(19) United States
(12) Patent Application Publication
(10) Pub. No.: US 2004/0149485 A1
(43) Pub. Date: Aug. 5, 2004

(54) Cable for a space elevator

(76) Inventor: Bradley C. Edwards, Bridgeport, WV (US)

Correspondence Address: BLACK LOWE & GRAHAM, PLLC, 701 FIFTH AVENUE, SUITE 4800, SEATTLE, WA, 98104, US

(21) Appl. No.: 10/637,485

(22) Filed: Aug. 8, 2003

Related U.S. Application Data
(60) Provisional application No. 60/402,341, filed on Aug. 8, 2002.

(51) Int. Cl. H01B 7/00

(52) U.S. Cl. 174/117 R

(57) ABSTRACT

A cable having interconnected fibers for use in a space elevator. The ribbon includes axial load bearing fibers that are interconnected so as to survive meteor damage and provide an easy surface for climbing. This ribbon may be deployed using current technology and utilized with a mechanical climbing system.

### PRIORITY CLAIM

This invention claims priority from U.S. Provisional Application No. 60/402,341, entitled “RIBBON CABLE FOR A SPACE ELEVATOR,” filed Aug. 8, 2002.

### BACKGROUND OF THE INVENTION

A ribbon cable for a space elevator is broadly described as a cable with one end attached to the surface of a planet such as Earth and the other end in space in earth orbit beyond a geosynchronous orbit (35,800 km altitude for the Earth). The competing forces of gravity at the lower end and outward “centrifugal” acceleration at the farther end keep the cable under tension and stationary over a single position on Earth. This cable, once deployed, can be ascended by mechanical means to Earth orbit or space. My invention is a viable cable that may be used for the construction of a space elevator. My cable will have the strength to mass ratio required for construction of a space elevator and be able to survive the environmental challenges of space and terrestrial weather. With this cable a space elevator can be built and the cost of accessing space will drop by a factor 10 to 100 initially and 100 to 10,000 in the long-term.

The concept of a space elevator apparently first appeared in an article by Artsutanov published in a Russian technical journal in 1960. In the following years the concept appeared several times in technical journals and then began to appear in science fiction. In 1999 NASA published a long-term view of the space elevator and a general concept of how such a system might be built. These works discussed the space elevator in generalities but few details on the construction of an actual system were given. The cable design and construction notes in these works are non-viable and relate to constructing round, hollow, tracked and extremely large (10 meter diameter scale) cables.

Tethers for use in space have been designed using braided or diagonal strands that redistribute the loads in the cable when part is damaged. However, these designs double the mass of the cable without adding strength to achieve the higher damage resistance. This method cannot be used in the construction of a space elevator due to the critical dependence of the system size and operation on the mass to strength ratio of the cable.

The invention can be broadly summarized as a cable having a large number of small, high-strength fibers aligned side-by-side and interconnected to preferably form a wide, thin ribbon. The individual fibers may have no interactions except through the interconnects. The interconnects themselves are designed to assume only part of the load from any broken fiber at each interconnect. This design allows individual fibers to be severed without creating high-stress areas resulting in rips across the ribbon. In addition the cable may be modified in its width profile and coatings to prevent damage by the space environment.

The specific design of this cable implies a deployment, build-up and use scenario. The initial cable may be spooled and sent to Earth orbit for deployment back down to Earth. Once the lower end of the cable is retrieved, climbing vehicles can ascend the cable and be used to strengthen the initial cable and deliver payloads to orbit.

### SUMMARY OF THE INVENTION

The invention may be broadly summarized as providing for a carbon cable for connecting an object orbiting a planet to a surface of the planet, the cable comprising both a plurality of axially oriented carbon nanotube fibers and a plurality of axially spaced, laterally oriented interconnects, each interconnect being disposed on at least some of the carbon nanotube fibers.

### BRIEF DESCRIPTION OF THE DRAWINGS

The preferred and alternative embodiments of the present invention are described in detail below with reference to the following drawings:

FIG. 1 is a schematic sectional view of the subject cable.

FIG. 2 is a graph showing approximate width of the preferred embodiment as function of altitude above the surface of the earth.

FIG. 3 is a schematic view of a portion of the axial fibers and an interconnect of the preferred embodiment.

FIG. 4 is a schematic illustration of a partial cross section of the preferred embodiment at 4-4 of FIG. 3.

FIG. 5 is an illustration of one embodiment of the space elevator system.

### DESCRIPTION OF THE PREFERRED EMBODIMENT

The cable design disclosed herein minimizes mass, maximizes axial strength and is resistant to damage by meteors, atomic oxygen and wind. This design is also optimized for use with friction drive locomotive systems that can be used in the climbing vehicles.

Any object in space when hit by a meteor will be damaged. Studies have shown that micrometeors impacting on a solid object will destroy a volume with a depth and diameter roughly twice that of the diameter of the meteor. Based on meteor flux measurements I calculate that a tether in space will be critically damaged in a relatively short period of time if it does not have a dimension greater than one inch. A round cable greater than 1 inch in diameter stretching 100,000 km for the space elevator has a mass of 90 million pounds, which would be too massive. This indicates a ribbon, sparce or solid sheet design with the width greater than one inch. The cable must also be designed such that when a hole is punched in it that its strength is not greatly diminished. Theoretically the best that can be done is that if, for example, 10% of the width is destroyed then the strength drops by 10%, a linear relation.

I examined several possible ribbon designs. A solid sheet ribbon I examined had high stress points at the sides of any hole created. These high stress points would result in rips across the cable if even a small void is created. A second design I considered is one where the ribbon is actually a set of completely disconnected fibers. As one fiber is severed it falls away. This set of fibers gives us the optimal performance of linear degradation but in the space elevator environment micrometeors would cut all the individual fibers quickly. An earlier proposed design is one of sparce, tensioned primary fibers with diagonal, lightly tensioned secondary fibers. In this design, when a primary fiber is severed the secondary lines take up the slack. This can be designed to relieve high tension points; however, it is at the cost of increasing the mass to strength ratio by a factor of two. For the space elevator this means a factor of 10 increase in the overall mass of the system which is unacceptable.

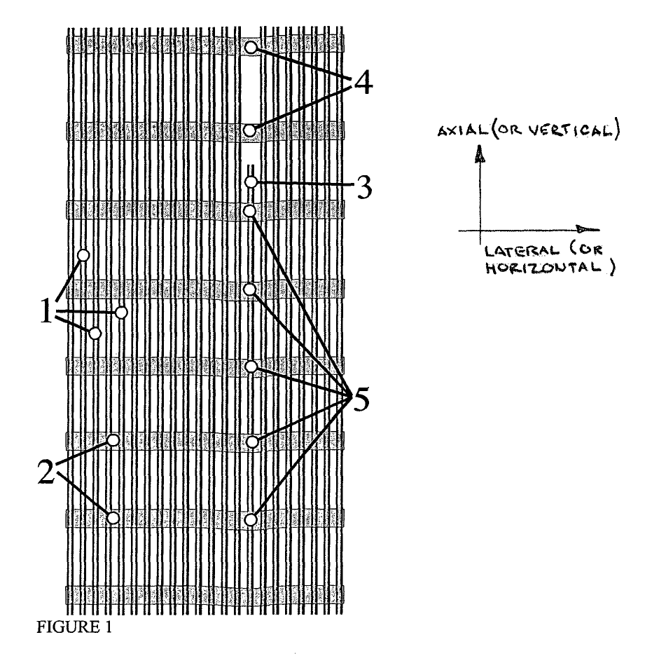

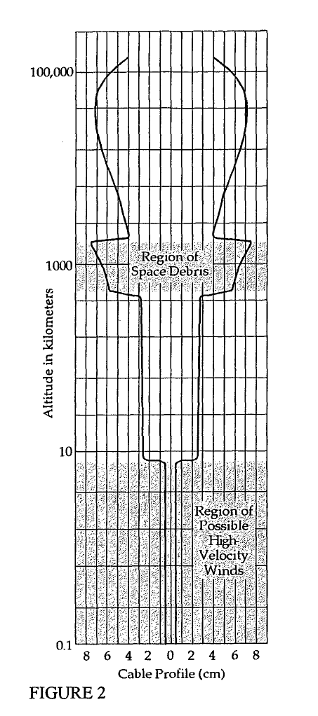

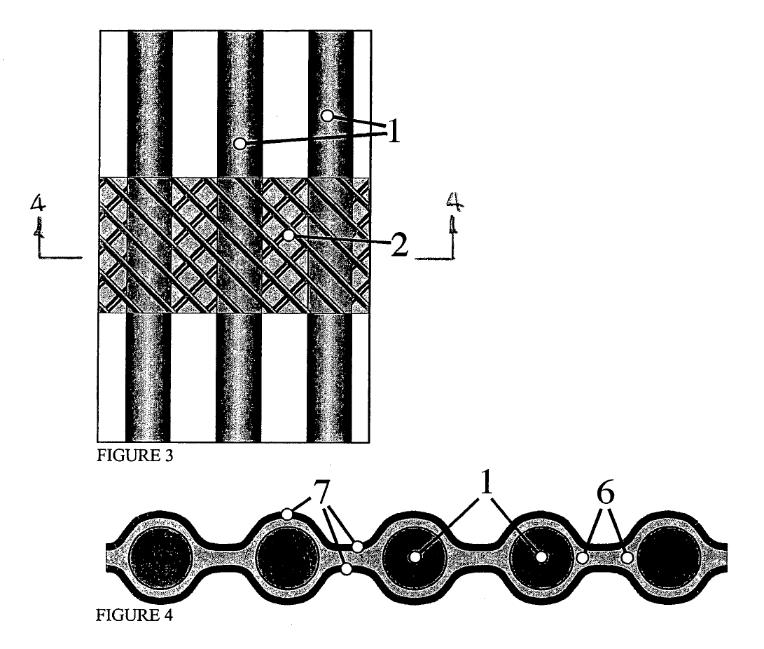

To address all of the performance requirements I have invented the ribbon illustrated in FIG. 1-4 which includes many individual axial fibers that are loosely interconnected. This embodiment has many small diameter fibers with laterally oriented interconnects across the cable and axially spaced at intervals much greater than the interconnect size. FIG. 1 illustrates axial fibers 1 and a plurality of interconnects 2 disposed thereon. A broken fiber 3, shown for illustration, has pulled through two interconnects 4 and is now held by the remaining interconnect 5. FIG. 2 illustrates the variation of the approximate width of the ribbon as deployed with altitude above the earth. A more detailed view of a portion of the cable is shown in FIG. 3. The preferred interconnect is formed of a tape sandwich or a woven section 1 millimeter wide holding the fibers up to tensions of about 1 GPa for a 10 micron diameter fiber. Above this tension the fiber slips through the interconnect. The result of this is that if a fiber is severed it contracts, pulling through the interconnects until the tension drops below 1 GPa at each interconnect. When this happens the tension is transferred from the severed fiber to the neighboring fibers through many interconnects over a length of many meters (FIG. 2). The excess tension on the neighboring fibers is also transferred to its adjacent fibers as the first fiber begins to stretch. If multiple fibers are severed at one location, then the interconnects may begin to slip on the intact fibers and transfer the tension directly to several neighboring fibers.

The space elevator cable can be constructed with currently known carbon nanotubes having maximum tensile 63 GPa and be used at one half of their maximum tensile strength. FIG. 4 is an enlarged schematic cross-sectional view of the cable at an interconnect. The axial fibers are shown surrounded by adhesive 6 and tape backings 7. The cable that I am proposing will have a 2 mm square cross sectional area of 10 micron diameter fibers or roughly 30,000 fibers. The proper adhesion strength for the interconnects may transfer about 1% of the load to the neighboring fibers. Standard adhesive tape exhibits this performance. I took two pieces of a standard off the shelf tape, 3M Super Bond 396 Polyester tape, having a 1.7 mil thick rubber-resin adhesive, a 4.1 mil total thickness, and an adhesion strength of 190N/100 mm to steel and sandwiched between them 7 micron diameter carbon fibers with tensile strength of 5 GPa (Toray Carbon Fibers America, Inc., T700S, 4.9 GPa tensile strength, 7 micron diameter). With as little as 2 millimeters of fiber in the tape sandwich I was able to hold the fibers to failure in tension. With thinner sandwiches the fibers pulled free. With a tape sandwich of one millimeter and 40% of this commercial adhesion I would achieve the performance required for a space elevator.

To survive the space environment I have considered metalized kapton tape. Kapton tape is commercially made in various thickness including 7.5 microns. If I place strips of 7.5 micron thick Kapton tape with a width of 1 mm on both sides of a flat array of nanotube fibers spaced every 20 cm I would have a total mass of metalized Kapton equal to roughly 10% of the total cable mass. Kapton appears to be a good backing for the space environment if metalized but an optimal and lighter mass substitute may be possible by using a carbon nanotube composite material.

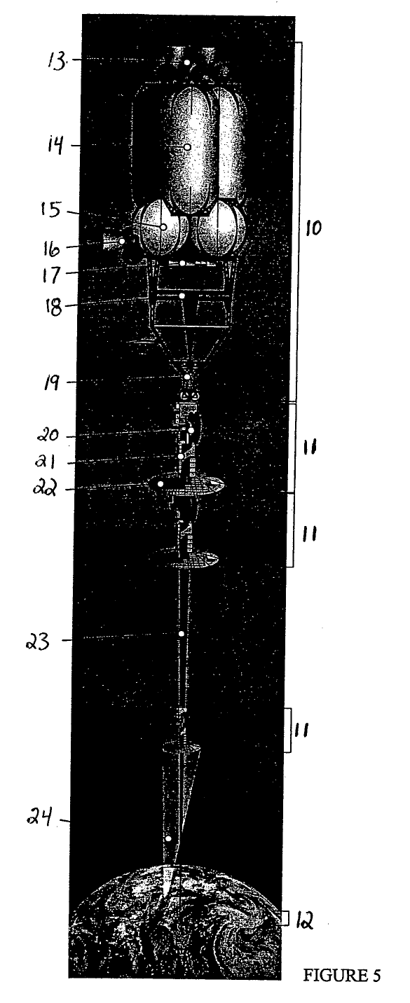

One embodiment of a space elevator system is shown in FIG. 5. The major sections include the deployment spacecraft 10, the climbing vehicles 11, the anchor station 12, and the cable 23. The components of these systems include a low-Earth orbit to geosynchronous orbit propulsion system on the deployment spacecraft (engine 13 and fuel 14), propulsion system on deployment spacecraft for use during cable deployment (engine 16 and fuel 15), deployment spacecraft control 17, cable spool 18, cable deployment braking mechanism 19, climbing vehicle payload 20, climbing vehicle control and drive systems 21, power receiver on the climbing vehicle 22, and power beam from Earth to climbing vehicles 24.

The initial deployment spacecraft may be launched in four pieces for assembly in low-Earth orbit and then electric or conventional propulsion may be used to move to a high-Earth orbit. Once in high-Earth orbit the cable will be deployed back down toward Earth using gravity gradient alignment. Multiple ribbons may be deployed and various components may be used as an end mass on the ribbon during deployment. Once the cable is fully deployed the spacecraft will become the counterweight on the upper end of the cable.

Ascending the ribbon will require the use of specifically designed climbing vehicles. A climber may include a power receiver (photovoltaic or microwave), controls, structures, and drive systems (electric motors and tracks). Climbers may be used to construct the first ribbon cable by splicing additional cables to the initially deployed cable.

The lower end of the claimed cable must be anchored appropriately to Earth. The anchor for the elevator may be an ocean-going mobile station located in the equatorial pacific to avoid lightning, high-winds and clouds and well as improve the performance of the system by eliminating off-angle forces during climber ascent.

Thus it can be seen that the present invention provides for a cable for a space elevator which cable incorporates many novel features and offers significant advantages over the prior art. Although only one embodiment of this invention has been illustrated and described, it is to be understood that obvious modifications can be made of it without departing from the true scope and spirit of the invention.

I claim:

1. A cable for connecting an object orbiting a planet to a surface of the planet, the cable comprising:
a plurality of axially oriented carbon nanotube fibers; and
a plurality of axially spaced, laterally oriented interconnects, each interconnect being disposed on at least some of the carbon nanotube fibers.

2. The cable of claim 1 wherein the nanotube fibers are laterally spaced.

3. The cable of claim 1 wherein at least one of the interconnects includes a plurality of spaced interconnect fibers.

4. The cable of claim 3 wherein the interconnect fibers are formed of carbon.

5. The cable of claim 3 wherein the interconnect fibers are biased with respect to the lateral orientation of the interconnects.

6. The cable of claim 3 wherein at least one of the interconnects includes a tape segment and the interconnect fibers are disposed on the tape.

7. The cable of claim 6 wherein the tape segment includes an adhesive and the interconnect fibers are bonded to the tape by the adhesive.

8. The cable of claim 3 wherein at least one of the interconnects includes a pair of tape segments and wherein at least some of the carbon nanotube fibers are disposed between the segments.

9. The cable of claim 8 wherein at least one of the tape segments includes an adhesive and wherein the interconnect fibers are bonded to the segment by the adhesive.

10. A cable for connecting an object orbiting the planet to a surface of the planet, the cable comprising:
a plurality of axially oriented carbon nanotube fibers; and
a plurality of spaced, laterally oriented interconnects, each interconnect being disposed on at least some of the carbon nanotube fibers and wherein at least one of the interconnects including a tape segment and a plurality of spaced interconnect fibers bonded to the tape.

11. Means for connecting an object orbiting a planet to a surface of the planet, the means comprising:
a plurality of axially oriented carbon nanotube fibers; and
a plurality of axially spaced, laterally oriented interconnects, each interconnect being disposed on at least some of the carbon nanotube fibers.
